(19) United States
(12) Patent Application Publication
(10) Pub. No.: US 2025/0298552 A1
(43) Pub. Date: Sep. 25, 2025

(54) IMAGE FORMING SYSTEM, NON-TRANSITORY COMPUTER READABLE MEDIUM STORING PROGRAM, AND IMAGE FORMING METHOD

(71) Applicant: FUJIFILM Business Innovation Corp., Tokyo (JP)

(72) Inventors: Yuki ANDO, Kanagawa (JP); Naohiro Tateishi, Kanagawa (JP); Tetsuhiro Inoue, Kanagawa (JP)

(73) Assignee: FUJIFILM Business Innovation Corp., Tokyo (JP)

(21) Appl. No.: 18/768,020

(22) Filed: Jul. 10, 2024

(30) Foreign Application Priority Data
Mar. 25, 2024 (JP) 2024-047564

(51) Int. Cl. G06F 3/12

(52) U.S. Cl. CPC G06F 3/1208; G06F 3/121; G06F 3/1234; G06F 3/1257

(57) ABSTRACT

An image forming system includes: an image forming portion that forms an image on a paper; an image scanning portion that scans the image formed on the paper; and a processor that controls the image forming portion based on a scanned image obtained through scanning of the image scanning portion, in which the processor is configured to: specify, based on a first scanned image that is corresponding to a first image formed on a first paper by the image forming portion and that is obtained through scanning of the image scanning portion, a first deviation amount representing a magnitude of a deviation of the first image with respect to the first paper; specify a first correction amount applied when the first image is formed; calculate a second correction amount for deviation correction based on the first deviation amount and the first correction amount; and correct a position where a second image is formed on a second paper, according to the second correction amount.

### CROSS-REFERENCE TO RELATED APPLICATIONS

This application is based on and claims priority under 35 USC 119 from Japanese Patent Application No. 2024-047564 filed Mar. 25, 2024.

### BACKGROUND

### (i) Technical Field

The present invention relates to an image forming system, a non-transitory computer readable medium storing a program, and an image forming method.

### (ii) Related Art

An image forming system is a system that forms an image on a paper. In the image forming system, an image forming position on the paper is changed due to various errors in paper conveyance processes, the expansion and contraction of the paper, and the like. Therefore, an image forming system including a function of correcting an image forming position while executing a print job has been proposed. More specifically, by scanning a first image formed on a first paper, which is a previous paper, and analyzing a scanned image obtained by scanning the first image, a deviation amount of the first image with respect to the first paper is obtained. A position where a second image is formed on a second paper, which is a subsequent paper, is corrected based on the deviation amount. A feedback correction based on such a scanned image is repeatedly executed.

JP2021-14061A discloses an image forming apparatus. In the image forming apparatus, a plurality of deviation amounts detected in a previous printing process (for example, a test printing process) are stored, and a position where each image is formed on each paper is corrected based on each stored deviation amount in a subsequent printing process (for example, a main printing process).

### SUMMARY

In an image forming system including a function of correcting an image forming position based on a scanned image, the scanned image is obtained from an image on a paper after correction of the image forming position. The deviation amount obtained from the scanned image is not an original deviation amount reflecting various deviation factors but is relative information representing excess or deficiency of the applied correction amount. Therefore, in a case where a correction amount is calculated based on only the deviation amount obtained from the scanned image, a problem of not being able to correctly correct the image forming position may occur.

Since the deviation amount is relative information, a consideration is made that a current correction amount is determined based on the deviation amount and a previous correction amount. In that case, a problem may occur in that the responsiveness of a feedback correction deteriorates due to the influence of the previous correction amount.

Aspects of non-limiting embodiments of the present disclosure relate to an image forming system, a non-transitory computer readable medium storing a program, and an image forming method that enable excellent correction of an image forming position in terms of accuracy or responsiveness than correction based on a relative deviation amount and a previous correction amount.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming system including: an image forming portion that forms an image on a paper; an image scanning portion that scans the image formed on the paper; and a processor that controls the image forming portion based on a scanned image obtained through scanning of the image scanning portion, in which the processor is configured to: specify, based on a first scanned image that is corresponding to a first image formed on a first paper by the image forming portion and that is obtained through scanning of the image scanning portion, a first deviation amount representing a magnitude of a deviation of the first image with respect to the first paper; specify a first correction amount applied when the first image is formed; calculate a second correction amount for deviation correction based on the first deviation amount and the first correction amount; and correct a position where a second image is formed on a second paper, according to the second correction amount.

### BRIEF DESCRIPTION OF THE DRAWINGS

Exemplary embodiment(s) of the present invention will be described in detail based on the following figures, wherein:

FIG. 1 is a schematic diagram showing an image forming system according to an exemplary embodiment;

FIG. 2 is a diagram showing a plurality of functions provided in a processor;

FIG. 3 is a diagram showing an example of a deviation of an image with respect to a paper;

FIG. 4 is a diagram showing a correction amount calculation method according to a comparative example;

FIG. 5 is a diagram showing a correction result according to the comparative example;

FIG. 6 is a diagram showing a correction amount calculation method according to the exemplary embodiment;

FIG. 7 is a diagram showing a correction result according to the exemplary embodiment;

FIG. 8 is a diagram showing a first information processing method according to the exemplary embodiment; and

FIG. 9 is a diagram showing a second information processing method according to the exemplary embodiment.

### DETAILED DESCRIPTION

Hereinafter, an exemplary embodiment of the present invention will be described in detail with reference to the accompanying drawings.

### (1) Outline of Exemplary Embodiment

An image forming system according to an exemplary embodiment includes an image forming portion, an image scanning portion, and a processor. The image forming portion forms an image on a paper. The image scanning portion scans the image formed on the paper to obtain a scanned image. The processor controls the image forming portion based on the scanned image obtained through scanning of the image scanning portion. Specifically, the processor specifies, based on a first scanned image that is corresponding to a first image formed on a first paper by the image forming portion and that is obtained through scanning of the image scanning portion, a first deviation amount representing a magnitude of a deviation of the first image with respect to the first paper. On the other hand, the processor specifies a first correction amount applied when the first image is formed. Moreover, the processor calculates a second correction amount for deviation correction based on the first deviation amount and the first correction amount and corrects a position where the second image is formed on a second paper according to the second correction amount.

The first deviation amount is a relative deviation amount that is generated under application of the first correction amount. Therefore, in the above configuration, in calculating the second correction amount, the first correction amount that causes a first deviation is considered together with the first deviation amount. By considering both the first deviation amount and the first correction amount, excellent correction may be performed in terms of accuracy or responsiveness.

There are various types of deviation of an image with respect to a paper, and examples of deviations include a deviation in a paper conveying direction, a deviation in a direction orthogonal to the paper conveying direction, a deviation in a rotational direction, and a deviation in a scale. Even in a case of correcting any of the deviations, the good correction may be performed as described above in consideration of the first deviation amount and the first correction amount. A calculation expression for calculating the second correction amount may be switched according to the property of the deviation.

The first correction amount may be specified by storing the first correction amount in a memory and reading out the first correction amount from the memory. In this case, an internal memory provided in the image forming system may be used, or an external memory provided in an external apparatus may be used. The first correction amount may be specified by storing the first correction amount in a medium other than the memory and extracting the first correction amount from the medium.

In the exemplary embodiment, the processor calculates, based on the first deviation amount and the first correction amount, a first actual deviation amount that is generated in a case where correction is not performed on an image forming position based on the first correction amount. Further, the processor calculates the second correction amount based on the first actual deviation amount. The actual deviation amount corresponds to an original deviation amount or a true deviation amount. However, strictly matching between the first actual deviation amount and the true deviation amount is not required. By setting the actual deviation amount as a basis, there is no need to set the previous correction amount as a basis for calculating the current correction amount (that is, the second correction amount). The calculation of the first actual deviation amount and the calculation of the second correction amount may be integrated. For example, the second correction amount may be calculated by executing a calculation expression including the calculation of the first actual deviation amount. In a case where the calculation of the first actual deviation amount and the calculation of the second correction amount are separated and then the first actual deviation amount is stored, the first actual deviation amount can be reused.

In the exemplary embodiment, the processor calculates the first actual deviation amount by subtracting a first correction amount from the first deviation amount and calculates the second correction amount based on the first actual deviation amount. According to this configuration, the first actual deviation amount may be easily obtained. The subtraction is a typical method for adapting to various deviations. Depending on the type of the deviation, other calculations (for example, division) using the first deviation amount and the first correction amount may be executed. As described above, the calculation of the first actual deviation amount and the calculation of the second correction amount may be collectively executed or may be separately executed.

In the exemplary embodiment, the processor calculates a first smoothed actual deviation amount based on a plurality of actual deviation amounts on a time axis including the first actual deviation amount. Further, the processor calculates the second correction amount based on the first smoothed actual deviation amount. The deviation amount is changed over time. By using the first smoothed actual deviation amount, the influence of the change in deviation amount over time is reduced. The first smoothed actual deviation amount may be further multiplied by a coefficient for gain adjustment or a coefficient for response adjustment. The smoothed actual deviation amount may be obtained as an average value of the plurality of actual deviation amounts, or the smoothed actual deviation amount may be obtained by applying other smoothing calculations with respect to the plurality of actual deviation amounts.

In the exemplary embodiment, the processor stores the first correction amount in the memory when the first image is formed. Moreover, the processor specifies the first correction amount by reading the first correction amount from the memory when the second correction amount is calculated. According to this configuration, the first correction amount is easily acquired and specified. Specifically, the processor sequentially saves a plurality of correction amounts, which are sequentially applied to a plurality of images, in the memory in order. On the other hand, the processor changes, in a case where each of the correction amounts is read from the memory, a reading position of the memory according to the number of waiting papers corresponding to a time difference between image formation time and image scan time. In general, the number of waiting papers is changed depending on the paper size, the paper conveyance speed, and the like. According to the above configuration, even in a case where such a change occurs, the deviation amount and the correction amount can be correctly associated with each other.

In the exemplary embodiment, the processor sequentially corrects a plurality of positions for forming a plurality of images based on a plurality of scanned images while executing a print job that includes printing instructions of the plurality of images. The above configuration is for performing real-time correction of an image forming position through feedback control from a downstream side to an upstream side.

A program, which is executed by the above processor, may be installed in the image forming system via a network or via a portable storage medium. The image forming system may be configured with one apparatus or a plurality of apparatuses from a physical perspective. The apparatuses may be connected to each other via a network. The image forming system is an information processing apparatus. The image forming system includes a non-transitory storage medium storing the above program.

### (2) Detail of Exemplary Embodiment

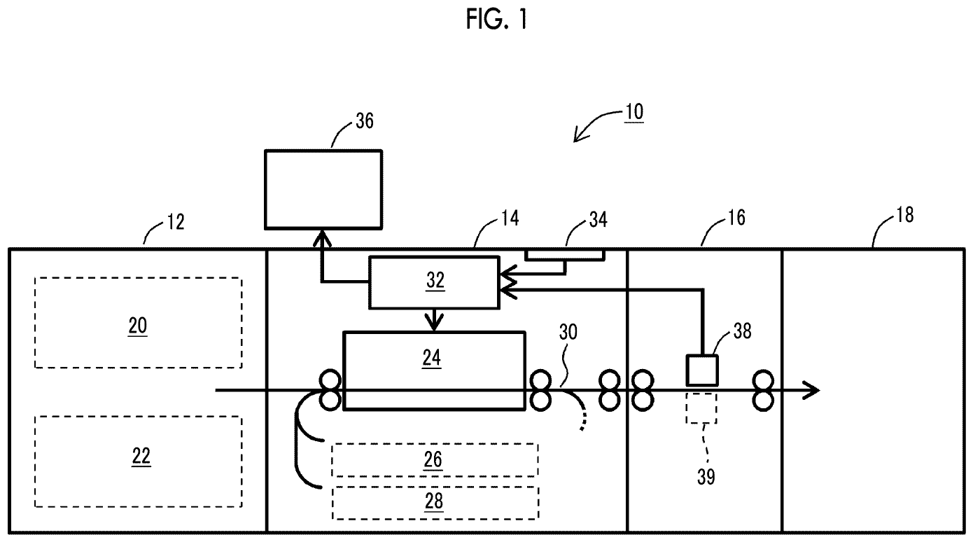

FIG. 1 shows a configuration example of the image forming system according to the exemplary embodiment. The image forming system 10 shown in the drawing sequentially forms a plurality of images on a plurality of papers and has a function of correcting the image forming position in real time through feedback control. The correction of the image forming position is also called registration correction or registration adjustment.

In FIG. 1, the image forming system 10 consists of a paper feeding apparatus 12, an image forming apparatus 14, an examination apparatus 16, and a post-processing apparatus 18. In the correction of the image forming position, at least the image forming apparatus 14 and the examination apparatus 16 function to correct the image forming position. The examination apparatus 16 may be incorporated in the image forming apparatus 14.

The paper feeding apparatus 12 includes two paper feeding trays 20 and 22. Each of the paper feeding trays 20 and 22 is a large paper feeding tray and can accommodate, for example, several thousand papers. The plurality of papers are sequentially supplied from the paper feeding apparatus 12 to the image forming apparatus 14. Each individual paper is a medium on which an image is formed.

The image forming apparatus 14 includes an image forming portion 24. In the exemplary embodiment, the image forming portion 24 is an image forming engine that forms each image on each paper in accordance with an electrophotographic method. More specifically, the image forming portion 24 includes a rotating intermediate transfer belt, and a plurality of photosensitive body units. The plurality of photosensitive body units are arranged in a movement direction of the intermediate transfer belt. A plurality of color toner images are sequentially transferred to the intermediate transfer belt by the plurality of photosensitive body units. As a result, the multiple toner images, which are generated by the above-described process, are transferred from the intermediate transfer belt to the paper. The image may be formed on the paper by using a method other than the electrophotographic method (for example, an ink jet method).

The image forming apparatus 14 includes paper feeding trays 26 and 28. As necessary, the plurality of papers are sequentially supplied from the paper feeding trays 26 and 28 to the image forming portion 24. The capacities of the respective paper feeding trays 26 and 28 are smaller than the capacities of the respective paper feeding trays 20 and 22. A reference numeral 30 denotes a paper conveyance path. The paper conveyance path 30 is provided over the paper feeding apparatus 12, the image forming apparatus 14, the examination apparatus 16, and the post-processing apparatus 18. In FIG. 1, the left side of the paper conveyance path 30 is the upstream side, and the right side thereof is the downstream side.

The image forming apparatus 14 includes a control portion 32. The control portion 32 controls an operation of each element in the image forming system 10. Image data is sequentially transferred from the control portion 32 to the image forming portion 24. The control portion 32 controls an operation of the image forming portion 24. That is, the control portion 32 controls the formation of each image on each paper. The control of the control portion 32 includes a deviation correction control in real time. The control portion 32 corrects various deviations of the image with respect to the paper. The correction of the deviation will be described in detail later.

The control portion 32 includes a processor that executes a program. The processor is, for example, a CPU. An operation panel 34 and a displayer 36 are connected to the control portion 32. The operation panel 34 is, for example, a screen panel with a touch sensor. Another input device may be connected to the control portion 32. The displayer 36 is, for example, a liquid crystal displayer. The entire or a part of the control portion 32 may be provided outside the image forming apparatus 14.

In general, the control portion 32 is connected to the information processing apparatus via a network and executes a print job sent from the information processing apparatus. The print job includes a plurality of images and printing instructions for the plurality of images. Hereinafter, in some cases, each input image is referred to as a main image.

The control portion 32 generates a composite image for each main image by composing a sub-image with the main image. The composite image is formed on each paper. The sub-image includes a plurality of marks for post-specifying various deviation amounts. Such a mark is also called a register mark. The image forming apparatus 14 includes a return paper conveyance path that is used in a case of forming an image on a back side of the paper, but the return paper conveyance path is not shown.

The examination apparatus 16 scans the image to examine the image formed on each paper. Specifically, the examination apparatus 16 includes an image sensor 38. The image sensor 38 corresponds to the image scanning portion. The image sensor 38 is an in-line sensor provided on the paper conveyance path 30. The image sensor 38 includes, for example, a plurality of detection elements arranged in a direction (hereinafter, also referred to as a horizontal direction in some cases) orthogonal to the paper conveying direction (hereinafter, also referred to as a vertical direction in some cases). A scanner that scans the image through laser scanning in a horizontal direction may be used as the image sensor 38. An image scanning device other than the above may be used as the image sensor 38.

The image sensor 38 is provided on the downstream side of the image forming portion 24 on the paper conveyance path 30. In the configuration example shown in the drawing, a scanned image (accurately, scanned image data) obtained through scanning of the image sensor 38 is transmitted to the control portion 32.

The examination apparatus 16 includes an image sensor 39 in addition to the image sensor 38. The image formed on a front side of the paper is scanned by the image sensor 38. The image formed on a back side of the paper is scanned by the image sensor 39. Regarding the correction of the image forming position, a flow of correction processing applied to the front side of the paper and a flow of correction processing applied to the back side of the paper are basically identical. Therefore, hereinafter, the correction processing applied to the front side of the image will be described.

The post-processing apparatus 18 includes a plurality of post-processing functions such as a trimming function, a folding function, and a punching function. In the post-processing apparatus 18, normally, a peripheral region of the paper is cut off for each paper. The peripheral region is a margin region where the plurality of marks or the like are formed. The sub-image is, for example, an image for forming the plurality of marks or the like with respect to a peripheral region of the paper. An apparatus including a discharge tray or a discharge stacker is usually provided in a subsequent stage of the post-processing apparatus 18.

The operation of the image forming system 10 will be summarized. A plurality of image-formed papers are sequentially discharged from the image forming portion 24 to a downstream side of the image forming portion 24. The image sensor 38 sequentially scans the plurality of images formed on the plurality of papers. A plurality of scanned images generated through scanning are sequentially transmitted from the image sensor 38 to the control portion 32. The control portion 32 calculates a plurality of types of deviation amounts for each scanned image by analyzing the scanned image. Further, the control portion 32 corrects the image forming position with respect to the paper based on the deviation amounts.

Examples of the plurality of types of deviations include a positional deviation due to an image shift in the vertical direction, a positional deviation due to an image shift in the horizontal direction, a positional deviation due to image rotation, a positional deviation due to a scale deviation, and the like. In practice, although the control portion 32 has a function of collectively correcting the positional deviations described above, in order to facilitate understanding of the configuration and the operation and effects of the functions according to the exemplary embodiment, hereinafter, only one type of deviation and correction corresponding to the deviation will be described.

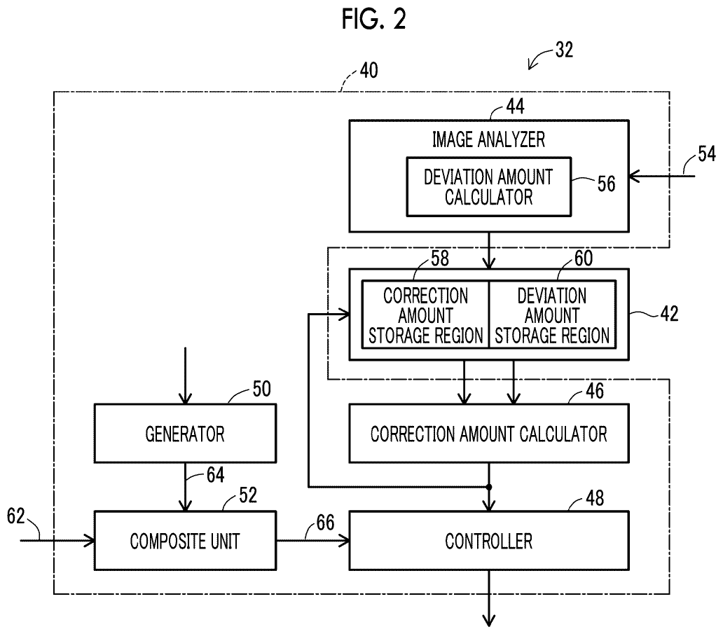

FIG. 2 shows a configuration example of the control portion 32. The control portion 32 includes a processor 40 and a memory 42. The memory 42 is configured with a single memory or a plurality of memories from a physical perspective. In FIG. 2, a plurality of functions exerted by the processor 40 are represented with a plurality of blocks. The processor 40 functions as an image analyzer 44, a correction amount calculator 46, a controller 48, a generator 50, and a composite unit 52. In FIG. 2, the configuration that is not directly related to the correction of the image forming position is not shown.

The image analyzer 44 includes a deviation amount calculator 56. The deviation amount calculator 56 calculates the deviation amount of the image with respect to the paper by analyzing the scanned image 54 for each scanned image 54. Specifically, the deviation amount calculator 56 calculates the deviation amount by comparing positions of the plurality of marks included in the scanned image with a plurality of reference positions. The deviation amount is a relative deviation amount that is generated under the correction of the image forming position. In the shown configuration example, the calculated deviation amount is stored in the memory 42.

The memory 42 includes a correction amount storage region 58 and a deviation amount storage region 60. The correction amounts, which are applied to each paper during the image formation, are stored in the correction amount storage region 58. More specifically, the correction amount storage region 58 is for storing the plurality of correction amounts arranged in order of paper numbers. The deviation amount storage region 60 stores the deviation amount calculated from each scanned image. More specifically, the deviation amount storage region 60 is for storing the plurality of deviation amounts arranged in the order of paper numbers.

The processor 40 manages a correspondence relationship between the plurality of stored correction amounts and the plurality of stored deviation amounts. That is, the specific correction amount, which is applied to the specific paper during the image formation, and the specific deviation amount that is calculated through scanning of the image formed on the specific paper, are associated with each other. A management mechanism other than the processor 40 may manage a correspondence relationship between the plurality of correction amounts and the plurality of deviation amounts. Each of the correction amount storage region 58 and the deviation amount storage region 60 has, for example, a ring buffer structure or a stack structure.

The correction amount calculator 46 specifies an actual deviation amount based on the correction amount and the deviation amount, which are in the correspondence relationship, and calculates the current correction amount based on the actual deviation amount. In practice, the correction amount calculator 46 calculates a smoothed actual deviation amount based on the plurality of correction amounts arranged on the time axis and the plurality of deviation amounts arranged on the time axis and calculates the current correction amount based on the smoothed actual deviation amount. The calculation of the correction amount will be described in detail later.

The controller 48 controls the operation of the image forming portion, and specifically corrects the image forming position based on the correction amount such that the deviation of the image with respect to the paper is resolved or reduced. The correction of the image forming position may include correction by mechanical control, in addition to correction by electronic control.

The generator 50 generates a sub-image 64 including a plurality of marks. The generator 50 may be configured in the memory. The composite unit 52 composes the sub-image 64 with each input image, that is, each main image 62 and generates a composite image 66. The composite image 66 is transmitted to the image forming portion through the controller 48 in the shown configuration example.

For example, in a case where a previous paper, which is a scanning target, is represented as a first paper and the scanned image, which is obtained through scanning of the image on the first paper, is represented as a first scanned image, the first deviation amount is calculated by analyzing the first scanned image. On the other hand, the first correction amount corresponding to the first deviation amount is specified. The correction amount calculator 46 calculates the first actual deviation amount based on the first correction amount and the first deviation amount and calculates a second correction amount, which is the current correction amount, based on the first actual deviation amount. In a case where an image formation is performed on the second paper, which is a subsequent paper, the correction of the image forming position is performed based on the second correction amount. In practice, as will be described later, the correction amount calculator 46 calculates a first smoothed actual deviation amount based on the plurality of actual deviation amounts including the first actual deviation amount and calculates a second correction amount based on the first smoothed actual deviation amount.

The actual deviation amount is a deviation amount that is generated in a case where the correction of the image forming position is not performed, that is, an original deviation amount or a true deviation amount estimated through the calculation. The actual deviation amount may be represented as an estimated actual deviation amount. The actual deviation amount only needs to be close to the true deviation amount, and strictly matching between the actual deviation amount and the true deviation amount is not required. The smoothed actual deviation amount is obtained by applying a smoothing calculation to the plurality of actual deviation amounts arranged on the time axis. Examples of the smoothing calculation include an average value calculation, a weighted average value calculation, and the like.

For example, 4 or 5 image-formed papers are present between the first paper, which is a scanning target, and the second paper, which is an image formation target. Each of the papers may be referred to as a waiting paper. Since a difference, that is, a time difference between the image formation time and the image scan time, is usually changed depending on paper size, paper conveyance speed, or the like, the number of waiting papers is also changed depending on factors described above.

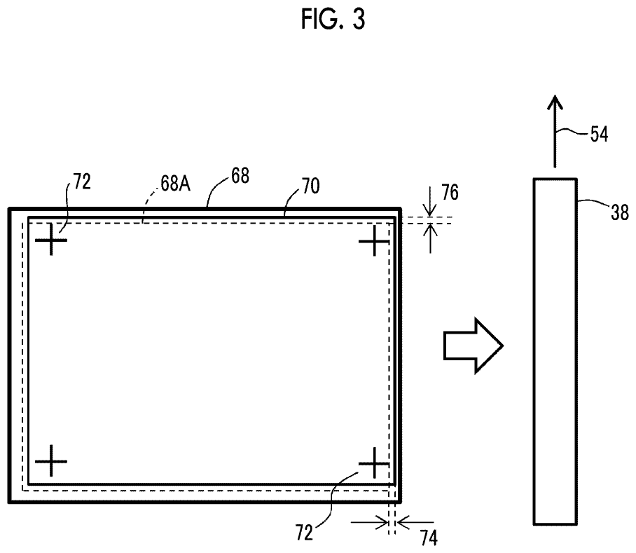

FIG. 3 schematically shows an example of the deviation. An image 70 is formed on the paper 68. The reference numeral 68A denotes a correct image formation region. A plurality of marks 72 are included in a peripheral region in the image 70. In FIG. 3, the right-left direction is the paper conveying direction, that is, the vertical direction. A direction orthogonal to the vertical direction is the horizontal direction.

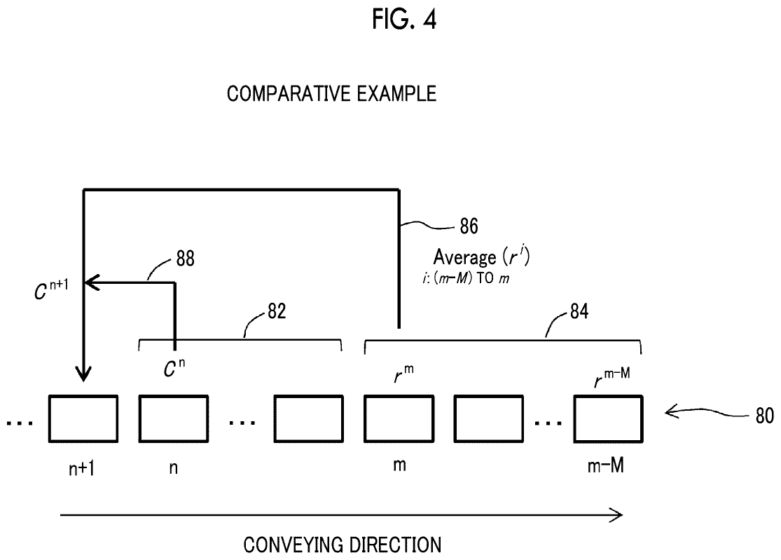

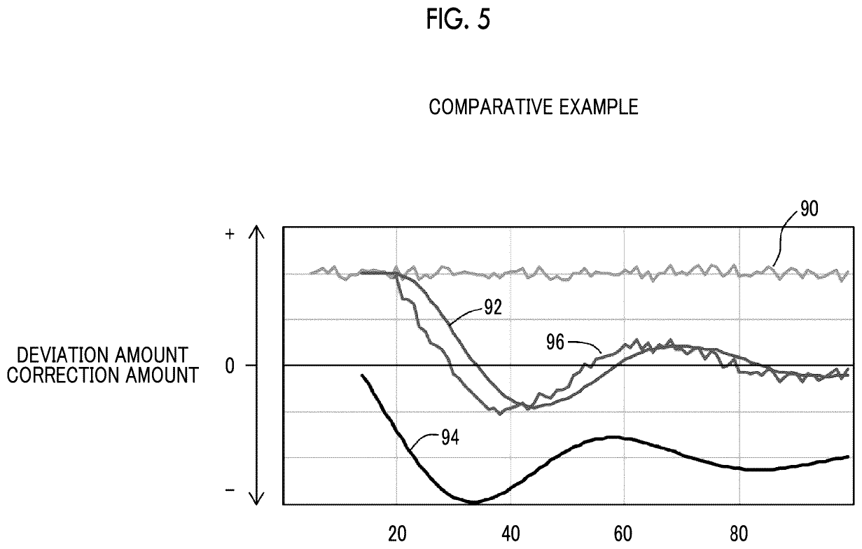

The image 70 is deviated with respect to the paper 68. Specifically, the reference numeral 74 denotes the deviation amount in the vertical direction, and the reference numeral 76 denotes the deviation amount in the horizontal direction. The image 70 is scanned by the image sensor 38 during the conveyance of the paper 68, and the scanned image 54 is generated through the scanning. The scanned image 54 is transmitted to the control portion. In the control portion, a position of each mark in the scanned image 54 is analyzed, and then the deviation amount 74 in the vertical direction and the deviation amount 76 in the horizontal direction are specified. The feedback control according to a comparative example will be described with reference to FIGS. 4 and 5. In FIG. 4, the right-left direction is the paper conveying direction. A plurality of papers configuring a paper row 80 are arranged in the paper conveying direction. “n” indicates a number of the paper immediately after the image formation. The correction amount applied to the paper during the image formation is Cⁿ. “n+1” indicates a number of the paper on which an image is to be formed. “m” indicates a number of the paper immediately after the image is scanned. The deviation amount, which is calculated through the scanning, is r^{m}. The deviation amount corresponding to the paper specified at “m-M” is r^{m-M}.

The reference numeral 82 denotes a plurality of papers waiting to be scanned, and the reference numeral 84 denotes a movement average period. The average (rⁱ) indicates a movement average value, which is an average value of “M+1” deviation amounts belonging to the movement average period 84. “i” takes a value from “m-M” to “m”.

In the comparative example, the current correction amount Cⁿ⁺¹ is calculated according to Expression (1) below.

$${C}^{n + 1} = - G \cdot {Average}_{i : ( m - M ) \sim m} ( {r}^{i} ) + {C}^{n} \qquad ( 1 )$$

In the above Expression (1), “G” is a gain, which is a coefficient for adjusting a response. The first term on the right side includes the above-described movement average value. Since the deviation amount is changed over time, the deviation amount is smoothed in order to stably calculate the correction amount. The second term on the right side is the previous correction amount.

In FIG. 4, the reference numeral 86 denotes a reference of the smoothed deviation amount, and the reference numeral 88 denotes a reference of the previous correction amount. In a case where the current correction amount is calculated based on the previous correction amount, the current correction amount is likely to be influenced by the previous correction amount. In the above Expression (1), since a phase difference is present between the first term and the second term on the right side, the responsiveness is a problem in calculating the current correction amount. According to the comparative example, in a case where a state change such as jamming occurs, the influence due to the state change is likely to remain for a long time.

FIG. 5 shows a correction result according to the comparative example. Here, in Expression (1), 10 is substituted for “M”, and 0.1 is substituted for “G”. The horizontal axis indicates the number of papers, which corresponds to the time axis. The vertical axis indicates the deviation amount and the correction amount.

A waveform 90 shows a change in deviation amount that is generated in a case where the correction is not performed. A waveform 92 shows a change in smoothed deviation amount in a case where the correction is performed. A waveform 94 shows a change in correction amount calculated based on the smoothed deviation amount. A waveform 96 shows a change in deviation amount after correction. According to the comparative example, as shown in the waveform 96, although the deviation amount converges to 0 with the passage of time, the deviation amount is relatively largely changed in a plus direction and a minus direction over a period until the convergence. That is, poor responsiveness can be seen.

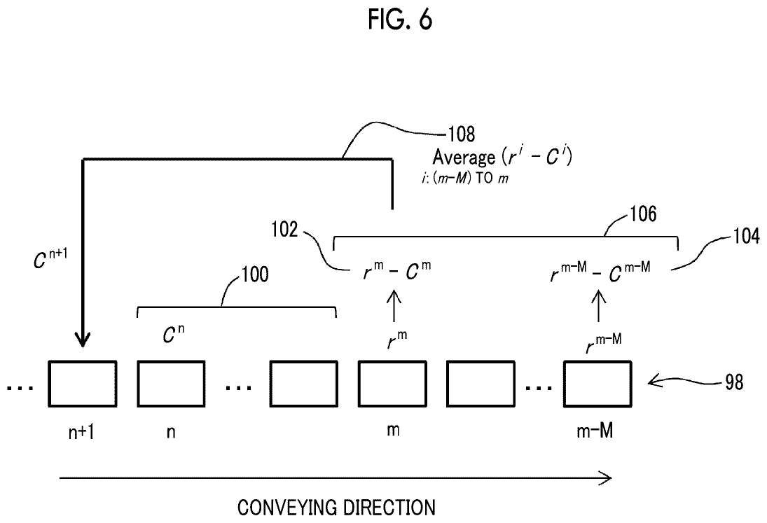

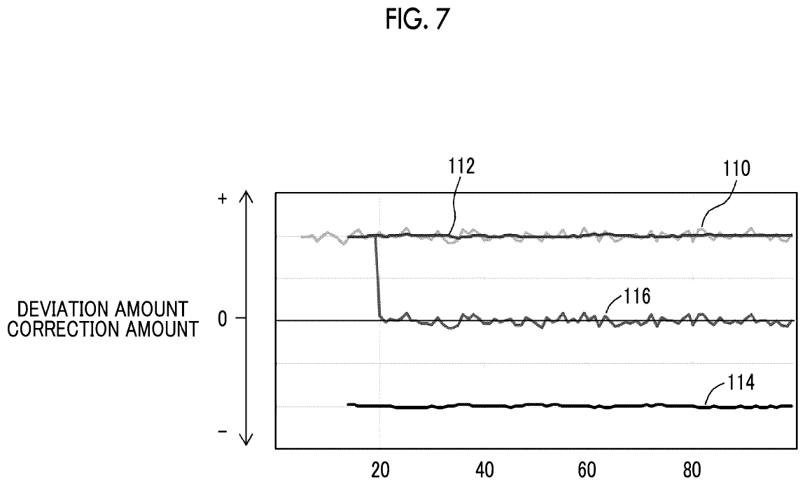

Next, feedback control according to the exemplary embodiment will be described with reference to FIGS. 6 and 7. In FIG. 6, the right-left direction is the paper conveying direction. A plurality of papers configuring a paper row 98 are arranged in the paper conveying direction. “n” indicates a number of the paper immediately after the image formation. The correction amount applied to the paper during the image formation is Cⁿ. “n+1” indicates a number of the paper on which an image is to be formed. “m” indicates a number of the paper immediately after the image is scanned. The deviation amount, which is calculated through the scanning, is r^{m}. The deviation amount corresponding to the paper specified at “m-M” is r^{m-M}.

The reference numeral 100 denotes the plurality of papers waiting to be scanned. In the exemplary embodiment, the actual deviation amount is calculated by subtracting the correction amount corresponding to the calculated deviation amount from the calculated deviation amount for each paper. The actual deviation amount is a deviation amount that is generated in a case where the correction of the image forming position is not performed and corresponds to the original deviation amount or the true deviation amount. The reference numeral 102 denotes the actual deviation amount r^{m}-C^{m} corresponding to the paper specified at “m”. Here, r^{m} is the deviation amount, and C^{m} is the correction amount. The reference numeral 104 denotes the actual deviation amount r^{m-M}-C^{m-M} corresponding to the paper specified at “m-M”. Here, r^{m-M} is the deviation amount, and C^{m-M} is the correction amount.

The reference numeral 106 indicates the movement average period. The average (rⁱ-Cⁱ) indicates the movement average value, and specifically, is an average value of “M+1” actual deviation amounts belonging to the movement average period 106. The movement average is one of smoothing methods, and the movement average value may be referred to as the smoothed actual deviation amount. “i” takes a value from “m-M” to “m”.

Specifically, the current correction amount Cⁿ⁺¹ is calculated according to the Expression (2) below.

$${C}^{n + 1} = - G \cdot {Average}_{i : ( m - M ) \sim m} ( {r}^{i} - {C}^{i} ) \qquad ( 2 )$$

In the above Expression (2), “G” is a gain, which is a coefficient for adjusting a response. The right side includes the above-described movement average value (that is, the smoothed actual deviation amount). Since the actual deviation amount is changed over time, the actual deviation amount is smoothed in order to stably calculate the correction amount. The above Expression (2) does not include the previous correction amount. As a result, a problem of the influence of the previous correction amount remaining or a problem of the response delay is avoided. “G” may be changed stepwise depending on “n”. For example, “G” may be changed from 0 (0%) to 1 (100%) from the first paper to the twentieth paper. In the above Expression (2), one may be substituted for “G”, and in this case, Expression (2) becomes simpler. The numerical value given to “G” may be changed depending on a status. For example, the numerical value given to “G” may be changed according to the number of papers waiting to be scanned or the time difference from the image formation time to the image scan time.

In FIG. 6, the reference numeral 108 denotes a reference of the smoothed actual deviation amount. The current correction amount Cⁿ⁺¹ is calculated based on the smoothed actual deviation amount. In a case where the calculation is performed, the reference to the previous correction amount Cⁿ is not necessary.

FIG. 7 shows a correction result according to the exemplary embodiment. Here, in Expression (2), ten is substituted for “M” and one is substituted for “G”. The horizontal axis indicates the number of papers, which corresponds to the time axis. The vertical axis indicates the deviation amount and the correction amount.

A waveform 110, which includes a large number of fine waves, indicates a change in actual deviation amount. A flat waveform 112 indicates a change in smoothed actual deviation amount. A waveform 114 indicates a change in correction amount. A waveform 116, which includes a large number of fine waves, indicates a change in deviation amount.

According to the exemplary embodiment, as shown in the waveform 116, the deviation amount converges to zero immediately, and a convergence state is maintained thereafter. The residual of the previous correction amount is not recognized, and the responsiveness is extremely good. As a result, the accuracy of the correction of the image forming position is improved.

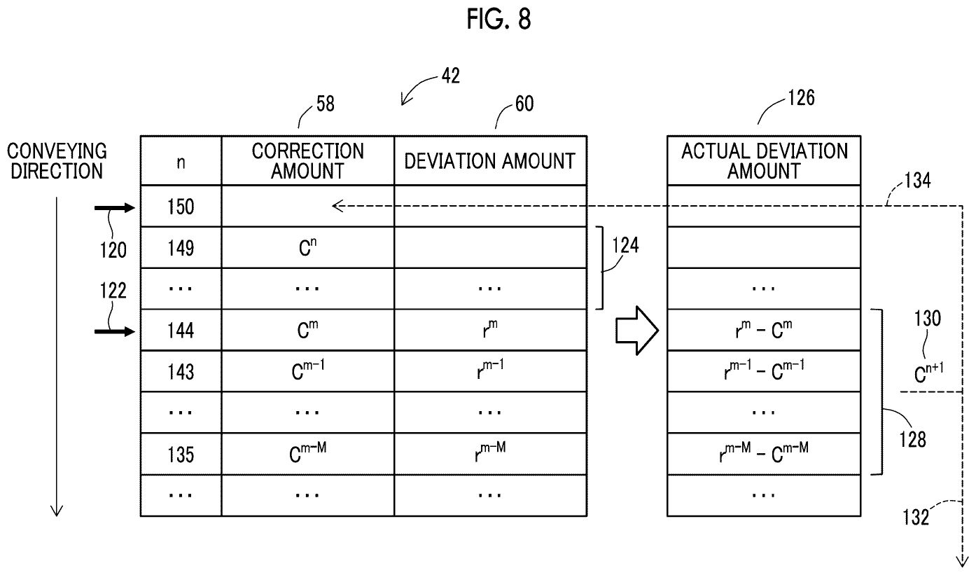

FIG. 8 schematically shows a first information processing method according to the exemplary embodiment. As described using FIG. 1, the memory 42 includes the correction amount storage region 58 and the deviation amount storage region 60. “n” indicates the paper number. The conveying direction corresponds to the time axis. A plurality of correction amounts are stored in the correction amount storage region 58 along the time axis. In the example shown in the drawing, the plurality of correction amounts are associated with the paper numbers. The deviation amount storage region 60 stores the plurality of deviation amounts along the time axis. In the example shown in the drawing, the plurality of deviation amounts are also associated with the paper numbers.

The reference numeral 120 indicates a current time point. The correction amount has not yet been calculated. The reference numeral 122 denotes time when the scanning is completed. The reference numeral 124 indicates a period in which scanning is awaited. The reference numeral 126 denotes the plurality of actual deviation amounts corresponding to the plurality of papers. A region for storing the plurality of actual deviation amounts may be provided on the memory 42. In a case where such a configuration is adopted, the calculated actual deviation amount can be reused, so that the calculation amount can be reduced.

The current correction amount 130 is calculated based on “M+1” actual deviation amounts belonging to the movement average period 128. The current correction amount 130 is used to control the image forming position (see the reference numeral 132) and is stored in the correction amount storage region 58 in the memory 42 (see the reference numeral 134). The above-described process is repeated for each paper.

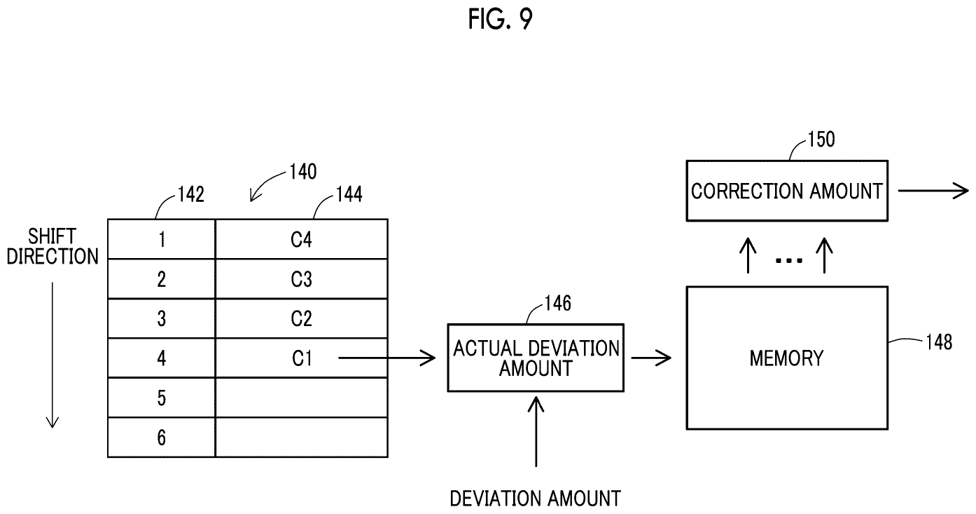

FIG. 9 schematically shows a second information processing method according to the exemplary embodiment. A memory 140 has a stack structure. Specifically, the memory 140 includes a plurality of storage cells 144 corresponding to a plurality of cell numbers (or hierarchy numbers) 142. Each time the correction amount is calculated, the calculated correction amount is stored in a first cell of the memory 140. In this case, one or a plurality of correction amounts already stored are shifted to a lower direction.

The number of papers waiting to be scanned is managed, and prior to the calculation of an actual deviation amount 146, a cell number, that is, a memory address corresponding to the deviation amount is specified. The correction amount is read from the storage cell associated with the cell number. The actual deviation amount 146 is calculated based on the read correction amount and the calculated deviation amount. The calculated actual deviation amount 146 is stored in the memory 148.

Prior to the calculation of the correction amount 150, the plurality of actual deviation amounts in the movement average period are read from the memory 148, and the correction amount 150 is calculated based on the plurality of actual deviation amounts. The image forming position is corrected based on the calculated correction amount 150, and the calculated correction amount 150 is stored in the memory 140. As described above, in the second information processing method, storing a plurality of deviation amounts is not necessary.

In the above-described exemplary embodiment, in calculating the smoothed actual deviation amount, first, the average value of the plurality of correction amounts and the average value of the plurality of deviation amounts may be calculated, and then a difference between the two average values may be calculated. In the above-described exemplary embodiment, in a case where a scale deviation is corrected, a division based on the correction amount and the deviation amount may be performed.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Note

(((1)))

An image forming system comprising:
an image forming portion that forms an image on a paper;
an image scanning portion that scans the image formed on the paper; and
a processor that controls the image forming portion based on a scanned image obtained through scanning of the image scanning portion,
wherein the processor is configured to:
   specify, based on a first scanned image that is corresponding to a first image formed on a first paper by the image forming portion and that is obtained through scanning of the image scanning portion, a first deviation amount representing a magnitude of a deviation of the first image with respect to the first paper;
   specify a first correction amount applied when the first image is formed;
   calculate a second correction amount for deviation correction based on the first deviation amount and the first correction amount; and
   correct a position where a second image is formed on a second paper, according to the second correction amount.
      (((2)))

The image forming system according to (((1))), wherein the processor is configured to:
calculate, based on the first deviation amount and the first correction amount, a first actual deviation amount that is generated in a case where correction is not performed on an image forming position based on the first correction amount; and
calculate the second correction amount based on the first actual deviation amount.
   (((3)))

The image forming system according to (((1))), wherein the processor is configured to:
calculate a first actual deviation amount by subtracting the first correction amount from the first deviation amount; and
calculate the second correction amount based on the first actual deviation amount.
   (((4)))

The image forming system according to (((2))) or (((3))), wherein the processor is configured to:
calculate a first smoothed actual deviation amount based on a plurality of actual deviation amounts on a time axis including the first actual deviation amount; and
calculate the second correction amount based on the first smoothed actual deviation amount.
   (((5)))

The image forming system according to any one of (((1))) to (((4))), wherein the processor is configured to:
store the first correction amount in a memory when the first image is formed; and
specify the first correction amount by reading the first correction amount from the memory when the second correction amount is calculated.
   (((6)))

The image forming system according to (((5))), wherein the processor is configured to:
sequentially store a plurality of correction amounts, which are sequentially applied to a plurality of images, in the memory; and
change, in a case where each of the correction amounts is read from the memory, a reading position of the memory according to the number of waiting papers corresponding to a time difference between image formation time and image scan time.
   (((7)))

The image forming system according to any one of (((1))) to (((6))), wherein the processor is configured to:
sequentially correct a plurality of positions for forming a plurality of images based on a plurality of scanned images while executing a print job that includes printing instructions of the plurality of images.
   (((8)))

A non-transitory computer readable medium storing a program that is executed in an image forming system including an image forming portion that forms an image on a paper, an image scanning portion that scans the image formed on the paper, and a processor that controls the image forming portion based on a scanned image obtained through scanning of the image scanning portion, the non-transitory computer readable medium storing a program causing the processor to execute a process comprising:
specifying, based on a first scanned image that is corresponding to a first image formed on a first paper by the image forming portion and that is obtained through scanning of the image scanning portion, a first deviation amount representing a magnitude of a deviation of the first image with respect to the first paper;
specifying a first correction amount applied when the first image is formed;
calculating a second correction amount for deviation correction based on the first deviation amount and the first correction amount; and
correcting a position where a second image is formed on a second paper, according to the second correction amount.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system comprising:
an image forming portion that forms an image on a paper;
an image scanning portion that scans the image formed on the paper; and
a processor that controls the image forming portion based on a scanned image obtained through scanning of the image scanning portion,
wherein the processor is configured to:
specify, based on a first scanned image that is corresponding to a first image formed on a first paper by the image forming portion and that is obtained through scanning of the image scanning portion, a first deviation amount representing a magnitude of a deviation of the first image with respect to the first paper;
specify a first correction amount applied when the first image is formed;
calculate a second correction amount for deviation correction based on the first deviation amount and the first correction amount; and
correct a position where a second image is formed on a second paper, according to the second correction amount.

2. The image forming system according to claim 1, wherein the processor is configured to:
calculate, based on the first deviation amount and the first correction amount, a first actual deviation amount that is generated in a case where correction is not performed on an image forming position based on the first correction amount; and
calculate the second correction amount based on the first actual deviation amount.

3. The image forming system according to claim 1, wherein the processor is configured to:
calculate a first actual deviation amount by subtracting the first correction amount from the first deviation amount; and
calculate the second correction amount based on the first actual deviation amount.

4. The image forming system according to claim 2, wherein the processor is configured to:
calculate a first smoothed actual deviation amount based on a plurality of actual deviation amounts on a time axis including the first actual deviation amount; and
calculate the second correction amount based on the first smoothed actual deviation amount.

5. The image forming system according to claim 3, wherein the processor is configured to:
calculate a first smoothed actual deviation amount based on a plurality of actual deviation amounts on a time axis including the first actual deviation amount; and
calculate the second correction amount based on the first smoothed actual deviation amount.

6. The image forming system according to claim 1, wherein the processor is configured to:
store the first correction amount in a memory when the first image is formed; and
specify the first correction amount by reading the first correction amount from the memory when the second correction amount is calculated.

7. The image forming system according to claim 6, wherein the processor is configured to:
sequentially store a plurality of correction amounts, which are sequentially applied to a plurality of images, in the memory; and
change, in a case where each of the correction amounts is read from the memory, a reading position of the memory according to the number of waiting papers corresponding to a time difference between image formation time and image scan time.

8. The image forming system according to claim 1, wherein the processor is configured to:
sequentially correct a plurality of positions for forming a plurality of images based on a plurality of scanned images while executing a print job that includes printing instructions of the plurality of images.

9. A non-transitory computer readable medium storing a program that is executed in an image forming system including an image forming portion that forms an image on a paper, an image scanning portion that scans the image formed on the paper, and a processor that controls the image forming portion based on a scanned image obtained through scanning of the image scanning portion, the non-transitory computer readable medium storing a program causing the processor to execute a process comprising:
specifying, based on a first scanned image that is corresponding to a first image formed on a first paper by the image forming portion and that is obtained through scanning of the image scanning portion, a first deviation amount representing a magnitude of a deviation of the first image with respect to the first paper;
specifying a first correction amount applied when the first image is formed;
calculating a second correction amount for deviation correction based on the first deviation amount and the first correction amount; and
correcting a position where a second image is formed on a second paper, according to the second correction amount.

10. An image forming method comprising:
specifying, based on a first scanned image that is corresponding to a first image formed on a first paper by an image forming portion and that is obtained through scanning of an image scanning portion, a first deviation amount representing a magnitude of a deviation of the first image with respect to the first paper;
specifying a first correction amount applied when the first image is formed;
calculating a second correction amount for deviation correction based on the first deviation amount and the first correction amount; and
correcting a position where a second image is formed on a second paper, according to the second correction amount.
